(19) United States
(12) Patent Application Publication
(10) Pub. No.: US 2012/0049812 A1
(43) Pub. Date: Mar. 1, 2012

(54) Switched-Mode Converter

(75) Inventors: Vincent Pinon, Grenoble (FR); Frédéric Hasbani, Hurtieres (FR)

(73) Assignee: STMicroelectronics SA, Montrouge (FR)

(21) Appl. No.: 13/217,065

(22) Filed: Aug. 24, 2011

(30) Foreign Application Priority Data
Aug. 26, 2010 (FR) 1056791

(51) Int. Cl. G05F 1/00

(52) U.S. Cl. 323/271

(57) ABSTRACT

A switched-mode converter includes first and second chopper transistors, and control means for maintaining the first and second chopper transistors respectively on and off during first operating phases. The first and second chopper transistors are maintained respectively off and on during second operating phases. An intermediary voltage is applied to the gate of the second transistor during intermediary phases taking place between the first and second phases. This intermediary voltage is close to the threshold voltage of the second transistor.

### CROSS-REFERENCE TO RELATED APPLICATIONS

This application claims the priority benefit of French patent application Ser. No. 10/56791, filed Aug. 26, 2010, entitled “Switched-Mode Converter,” which is hereby incorporated by reference to the maximum extent allowable by law.

### TECHNICAL FIELD

The present invention relates to switched-mode converters. It especially aims at improving the power efficiency and the voltage capacity of a switched-mode converter.

### BACKGROUND

FIG. 1 is an electric diagram of a voltage step-down switched-mode converter, capable of converting a DC input voltage V_{IN} into a DC output voltage V_{OUT} of lower value. Such a converter is often designated in the art as a “buck” converter.

The converter of FIG. 1 comprises a P-channel MOS transistor 1 and an N-channel MOS transistor 2, in series between a high terminal A and a low terminal B (or ground terminal) of a voltage source 5, for example, a battery, providing input voltage V_{IN}. The sources (S) of transistors 1 and 2 are respectively connected to terminals A and B, and the drains (D) of transistors 1 and 2 are connected to a common node C. An inductance 7 and a capacitor 9 are series-connected between node C and terminal B.

Output voltage V_{OUT} of the converter is available across capacitor 9, that is, between a high output terminal E, common to inductance 7 and to capacitor 9, and low terminal B.

The gates of transistors 1 and 2 are respectively capable of receiving control signals VG1 and VG2. Transistors 1 and 2 are here used as switches or chopper transistors. The regulation of output voltage V_{OUT} is performed by switching node C (via transistors 1 and 2) between a first state, connected to high terminal A, and a second state, connected to low terminal B, at a given frequency called chopping frequency.

During first operating phases, called charge phases, transistors 1 and 2 are respectively closed (on) and open (off), that is, node C is connected to terminal A. The current in inductance 7 increases. Inductance 7 temporarily stores part of the power provided by voltage source 5, while capacitor 9 charges.

During second operating phases, called discharge phases, transistors 1 and 2 are respectively open (off) and closed (on), that is, node C is connected to terminal B. Inductance 7 behaves as a current generator, limiting the discharge speed of capacitor 9.

If the converter operates at constant frequency and in continuous conduction mode (that is, the current which crosses inductance 7 never becomes zero), output voltage V_{OUT} remains substantially constant, close to α*V_{IN}, where α is the duty factor of the on time of transistor 1 to the full switching cycle period.

Switching transistors 1 and 2 are sized to enable the flowing of the converter charge and discharge currents. Other transistors, not shown, and generally smaller, may be provided to establish control signals VG1 and VG2 of transistors 1 and 2.

Switching transistors 1 and 2 must never be on at the same time, which would amount to short-circuiting input voltage source 5.

FIGS. 2A and 2B are timing diagrams illustrating the variation, in a normal operating mode, of control signals VG1 and VG2 of switching transistors 1 and 2 of the converter of FIG. 1.

In a first operating phase (charge phase), between a time t0 and a time t1 subsequent to time t0, signals VG1 and VG2 are at low values, respectively VG1_{L} and VG2_{L}, thus maintaining transistors 1 and 2 respectively on and off.

At time t1, signal VG1 switches to a high value VG1_{H}, thus turning off transistor 1.

At a time t2, little after time t1, signal VG2 switches to a high value VG2_{H}, thus turning on transistor 2.

In a second operating phase (discharge phase), between time t2 and a time t3 subsequent to time t2, signals VG1 and VG2 are at high values, respectively VG1_{H} and VG2_{H}, thus maintaining transistors 1 and 2 respectively off and on.

At time t3, signal VG2 switches to a low value VG2_{L}, thus turning off transistor 2.

At a time t4, little after time t3, signal VG1 switches to a low value VG1_{L}, thus turning on transistor 1, and the switching cycle starts over.

Intermediary phases t1-t2 and t3-t4 during which transistors 1 and 2 are both off are relatively short, but are necessary to ascertain that, in transitions between the charge (t041) and discharge (t2-t3) phases, transistors 1 and 2 are never on at the same time, which would amount to short-circuiting voltage source 5.

To ensure the continuity of the current between the intermediary phases (t1-t2, t3-t4) and the charge and discharge phases (t0-t1, t2-t3), a free wheel diode 11, forward-connected between terminals B and C, is provided (FIG. 1). Diode 11, for example, is the internal source-drain diode of transistor 2, the source of transistor 2 being connected to the substrate of this transistor.

During charge phases t0-t1, diode 11, reverse-biased, is non-conductive.

During discharge phases t2-t3, transistor 2, in parallel with diode 11, is closed (on). The discharge current thus flows through transistor 2 which provides a conduction path of lower voltage drop than diode 11.

Conversely, during intermediary phases t1-t2 and t3-t4, transistor 2 is off (non-conductive), and a discharge current flows through diode 11.

A disadvantage of such a converter is the non-negligible amount of power dissipated in diode 11 during intermediary phases t1-t2 and t3-t4, which cause a degradation of the power efficiency of the converter. In the on state, transistors 1 and 2, for example, have a voltage drop approximately ranging from 0.01 to 0.2 V and dissipate a negligible amount of power. However, in the on state, diode 11 has a voltage drop approximately ranging from 0.6 to 0.8 V and dissipates a significant amount of power.

Further, when a discharge current flows through the converter, a greater voltage drop between terminals B and C implies that transistor 1 (off) must withstand a greater voltage. A disadvantage of the converter described in relation with FIGS. 1 to 2B is the stress undergone by transistor 1 during intermediary phases t1-t2 and t3-t4, due to the relatively large voltage drop (approximately ranging from 0.6 to 0.8 V) between terminals B and C (diode 11).

Further, in an integrated circuit, the conduction through a PN diode (diode 11) inevitably introduces a risk of triggering a possible parasitic bipolar transistor, which may further degrade the power efficiency, and even result in a latch-up situation.

### SUMMARY OF THE INVENTION

Thus, an embodiment provides a switched-mode converter overcoming at least some of the disadvantages of present converters.

An embodiment provides such a converter which has a better power efficiency than present converters.

An embodiment provides such a converter which is easy to manufacture.

Thus, an embodiment provides a switched-mode converter comprising first and second chopper transistors, and control circuitry configured to maintain the first and second transistors respectively on and off during first operating phases; to maintain the first and second transistors respectively off and on during second operating phases; and to apply an intermediary voltage to the gate of the second transistor during intermediary phases taking place between the first and second phases. This intermediary voltage is close to the threshold voltage of the second transistor.

According to an embodiment, the first and second transistors respectively are a P-channel MOS transistor and an N-channel MOS transistor, in series between high and low terminals of the converter.

According to an embodiment, the intermediary voltage is smaller by 50 mV to 150 mV than the threshold voltage of the second transistor.

According to an embodiment, the intermediary phases have a duration ranging between 1% and 10% of the full switching cycle period.

According to an embodiment, the above-mentioned control circuitry comprises a first switch for connecting the gate of the first transistor to a terminal at a first voltage during the first phases, and to a terminal at a second voltage during the second phases and the intermediary phases. A second switch connects the gate of the second transistor to a terminal at a third voltage during the first phases, to a terminal at a fourth voltage during the second phases, and to an intermediary node during intermediary phases. The control circuitry also applies the intermediary voltage to the intermediary node during intermediary phases.

According to an embodiment, a diode-assembled transistor, biased by a current source is used for applying the intermediary voltage.

According to an embodiment, the switched-mode converter is connected as a voltage step-down transformer.

According to an embodiment of the present invention, the switched-mode converter is connected as a voltage step-up transformer.

According to an embodiment, the switched-mode converter is connected as a class-D amplifier.

The foregoing will be discussed in detail in the following non-limiting description of specific embodiments in connection with the accompanying drawings.

### BRIEF DESCRIPTION OF THE DRAWINGS

FIG. 1, previously described, is an electric diagram of a buck converter;

FIGS. 2A and 2B, previously described, are timing diagrams illustrating the variation of the switching transistor control signals in a buck converter;

FIGS. 3A and 3B are timing diagrams illustrating the variation of the switching transistor control signals in an embodiment of a buck converter;

FIG. 4 is an electric diagram of an embodiment of a buck converter;

FIG. 5 is an electric diagram of an alternative embodiment of the converter of FIG. 4; and

FIG. 6 is an electric diagram of an alternative embodiment of the converter of FIG. 5.

### DETAILED DESCRIPTION OF ILLUSTRATIVE EMBODIMENTS

For clarity, the same elements have been designated with the same reference numerals in the different drawings.

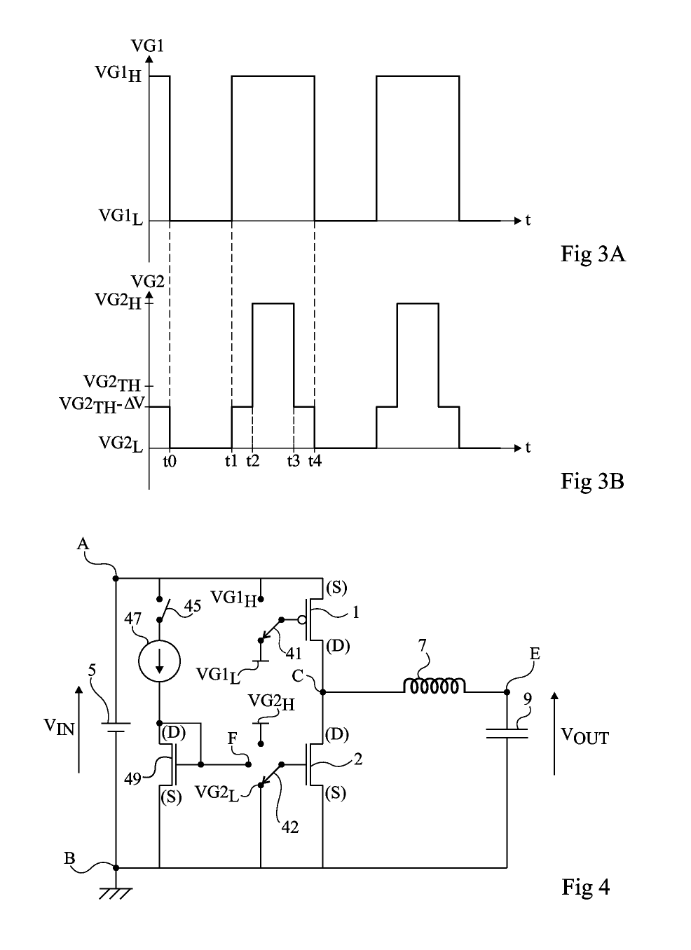

FIGS. 3A and 3B are timing diagrams illustrating the variation of switching transistor control signals VG1 and VG2 in an embodiment of a buck converter.

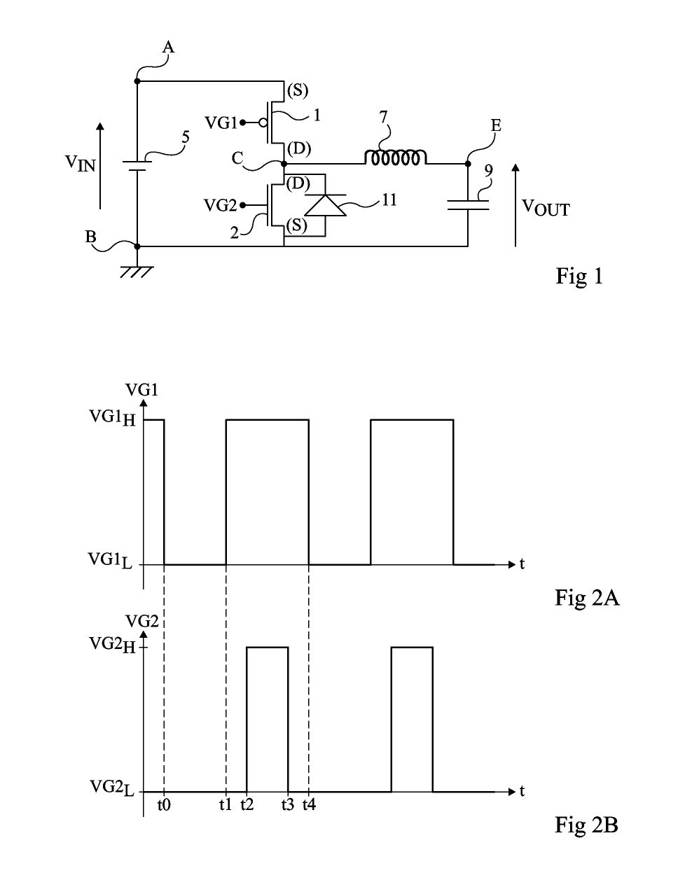

A converter of the type described in relation with FIG. 1, but in which switching transistors 1 and 2 are controlled according to a sequence different from that described in relation with FIGS. 2A and 2B, is considered here.

It is provided here, during intermediary phases t1-t2 and t3-t4, between charge phases t0-t1 and discharge phases t2-t3 of the converter, to bias the gate of transistor 2, not to a low value VG2_{L} as described in relation with FIG. 2B, but to an intermediary value VG2_{TH}−ΔV slightly lower than threshold voltage VG2_{TH} of transistor 2.

When the gate of transistor 2 is maintained at a level close to its threshold voltage, for a positive voltage between its drain (D), that is, node C, and its source (S), that is, terminal B, transistor 2 remains non-conductive. However, if the voltage of node C becomes lower than the voltage of node B, node C becomes the source of transistor 2. The gate-source voltage of transistor 2 then becomes equal to voltage VG2_{TH}−ΔV biasing the gate of transistor 2 plus the voltage between terminal B and node C. Accordingly, if the voltage between terminal B and node C exceeds ΔV, transistor 2 turns on.

Thus, transistor 2 behaves as a passive rectifier with a low voltage drop.

In a first operating phase (charge phase), between a time t0 and a time t1 subsequent to time t0, signals VG1 and VG2 are at low values, respectively VG1_{L} and VG2_{L}, thus maintaining transistors 1 and 2 respectively on and off.

At time t1, signal VG1 is set to a high value VG1_{H}, thus turning off transistor 1, and signal VG2 is set to intermediary value VG2_{TH}−ΔV. Transistor 2 is then non-conductive for a positive voltage C-B, thus avoiding a possible short-circuit of voltage source 5 in case of a late turning-off of transistor 1. However, as soon as transistor 1 turns off, to ensure the continuity of the current in inductance 7, a discharge current tends to flow in the converter. This current tends to flow from ground B to node C, the voltage of node C then becoming lower than the voltage of ground terminal B. Transistor 2 self-triggers under the effect of this current. Transistor 2 then provides a conduction path for the discharge current having a much smaller voltage drop than the voltage drop of diode 11 of FIG. 1. As an example, during intermediary phase t1-t2, the voltage drop between node C and terminal B approximately ranges from 0.2 to 0.4 V, compared with the voltage drop from 0.6 to 0.8 V in the case described in relation with FIGS. 2A and 2B. The amount of power dissipated during this intermediary phase is thus decreased, as well as the stress undergone by transistor 1.

At a time t2, little after time t1, signal VG2 switches to a high value VG2_{H}, causing the full closing of transistor 2. The voltage drop across transistor 2 then approximately ranges from 0.01 to 0.2 V.

In a second operating phase (discharge phase), between time t2 and a time t3 subsequent to time t2, signals VG1 and VG2 are at high values, respectively VG1_{H} and VG2_{H}, thus maintaining transistors 1 and 2 respectively off and on.

At time t3, signal VG2 is set to intermediary value VG2_{TH}−ΔV. Transistor 2 then remains on for a positive voltage B-C, thus ensuring the continuity of the discharge current while decreasing the amount of dissipated power with respect to a converter of the type described in relation with FIGS. 1 to 2B. Conversely, transistor 2 becomes non-conductive for a positive voltage C-B.

At a time t4, a little after time t3, signal VG1 is set to a low value VG1_{L}, thus causing the turning-on of transistor 1, and signal VG2 is set to a low value VG2_{L}, causing the turning-off of transistor 2. The switching cycle then starts again.

The provided control mode enables to decrease the power dissipated during intermediary phases t1-t2 and t3-t4, and thus to improve the converter efficiency.

According to another advantage, during the intermediary phases, as soon as transistor 2 starts conducting, no further current flows through diode 11. The risk of triggering a possible parasitic bipolar transistor in the circuit is thus strongly decreased.

Intermediary value VG2_{TH}−ΔV for biasing the gate of transistor 2 during phases t1-t2 and t3-t4 ranges between high and low control values VG2_{H} and VG2_{L} of transistor 2. As an example, for a transistor 2 having its threshold voltage VG2_{TH} ranging between 0.3 and 0.8 V, an intermediary bias voltage VG2_{TH}−ΔV smaller by 50 mV to 150 mV than the threshold voltage is provided. Further, if the converter operates at a chopping frequency ranging between 10 and 100 MHz, the full period of the switching cycle (t0-t4) ranges between 10 and 100 ns. It is then, for example, provided for intermediary phases t1-t2 and t3-t4 during which the gate voltage of transistor 2 is maintained at intermediary value VG2_{TH}−ΔV to have a duration approximately ranging between 1 and 5 ns. More generally, it is provided for the intermediary phases to have a duration approximately ranging from 1% to 10% of the full period of the switching cycle. The present invention is however not limited to this specific case.

FIG. 4 is an electric diagram schematically showing an embodiment of a buck converter. The converter of FIG. 4 comprises the elements of the converter of FIG. 1, and further comprises circuitry to control switching transistors 1 and 2 according to a sequence of the type described in relation with FIGS. 3A and 3B.

A switch 41 is provided to connect the gate of transistor 1 to a node or rail at low voltage VG1_{L} during charge phases t0-t1; and to a node or rail at high voltage VG1_{H} (here, node A) during intermediary and discharge phases t1-t4.

A switch 42 is provided to connect the gate of transistor 2 to a node or rail at low voltage VG2_{L} (here, node B) during charge phases t0-t1; to a node or rail at high voltage VG2_{H} during discharge phases t2-t3; and to an intermediary node F during intermediary phases t1-t2 and t3-t4.

A switch 45, a current source 47, and an N-channel MOS transistor 49 are series-connected between terminals A and B. The source (S) of transistor 49 is connected to terminal B, and the drain (D) of transistor 49 is connected to current source 47. Transistor 49 is diode-assembled (gate and drain connected) and the gate of transistor 49 is connected to node F.

During intermediary phases t1-t2 and t3-t4, switch 45 is on, and a constant current is imposed by source 47 in diode 49. A voltage settles at node F, with a value depending on the value of the current imposed by source 47. The imposed current is selected to be such that the voltage at node F settles at the aimed intermediary value VG2_{TH}−ΔV.

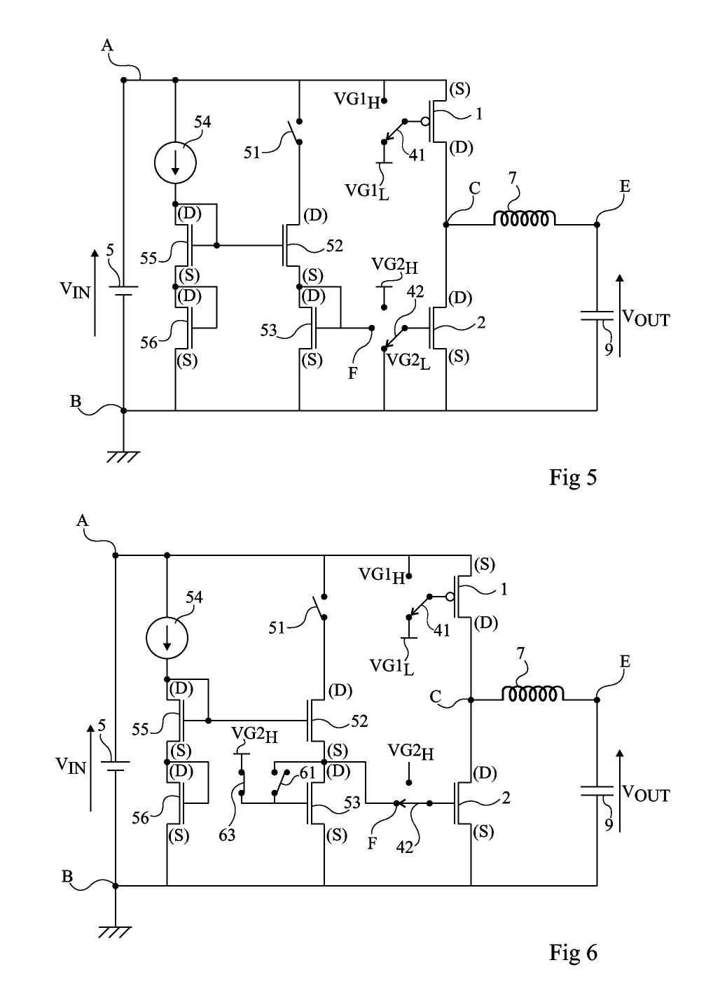

FIG. 5 is an electric diagram of an alternative embodiment of the buck converter of FIG. 4. In this alternative embodiment, intermediary voltage VG2_{TH}−ΔV is applied to the gate of transistor 2 with a low impedance. This enables to more efficiently control transistor 2, and especially to have the control voltage settle more rapidly on the gate of transistor 2.

The converter of FIG. 5 has elements common with the converter of FIG. 4, and only differs from this converter by the means used to generate intermediary voltage VG2_{TH}−ΔV on node F.

A switch 51 and two N-channel MOS transistors 52 and 53 are series-connected between terminals A and B. The drain (D) of transistor 52 and the source (S) of transistor 53 are respectively connected to switch 51 and to terminal B. The source (S) of transistor 52, the drain (D) of transistor 53, and the gate of transistor 53 are connected to node F.

Further, a current source 54 and two N-channel MOS transistors 55 and 56 are series-connected between terminals A and B. The drain (D) of transistor 55 and the source (S) of transistor 56 are respectively connected to current source 54 and to terminal B. The source (S) of transistor 55 and the drain (D) of transistor 56 are connected to the gate of transistor 56. Further, the drain (D) and the gate of transistor 55 are connected to the gate of transistor 52.

During intermediary phases t1-t2 and t3-t4, switch 51 is on. A constant current is imposed by source 54 in transistor 55, and a voltage settles at node F, with a value depending on the value of the current imposed by source 54. The imposed current is selected to be such that the voltage at node F settles at the aimed intermediary value VG2_{TH}−ΔV.

FIG. 6 is an electric diagram of an alternative embodiment of the buck converter of FIG. 5. The converter of FIG. 6 comprises the same elements as the converter of FIG. 5. However, unlike in the converter of FIG. 5, the gate and the drain of transistor 53 are not directly interconnected, but are connected via a switch 61. Further, a switch 63 is provided between the gate of transistor 53 and a terminal or rail of high voltage VG2_{H}.

During charge phases t0-t1, the gate of transistor 1 is set to a low voltage VG1_{L} via switch 41, and the gate of transistor 2 is connected to node F via switch 42. Further, switches 61 and 63 are respectively off and on, so that transistor 53 is turned on. Node F then is at a low voltage, substantially equal to the voltage of terminal B, thus maintaining transistor 2 off.

During discharge phases t2-t3, the gate of transistor 1 is set to a high voltage via switch 41, and the gate of transistor 2 is set to a high voltage via switch 42.

During intermediary phases t1-t2 and t3-t4, the gate of transistor 1 is set to a high voltage via switch 41, and the gate of transistor 2 is connected to node F via switch 42. Further, transistors 61 and 63 are respectively on and off. The operation is then identical to the case of FIG. 5. Switch 51 is on and intermediary voltage VG2_{TH}−ΔV settles at node F.

This variation enables to minimize the size of switch 42 by using transistor 53 to ensure some state switchings.

As a variation, switches 61 and 63 may be replaced with a single switch between high voltage terminal VG2_{H} and node F. Further, a permanent connection between the gate of transistor 2 and node F, as well as a switch 42 having two states (off and on) between node F and high voltage terminal VG2_{H} may be provided, switches 42, 51, and 61 then enabling to control the different operating phases.

More generally, it will be within the abilities of those skilled in the art to use any adapted means for controlling the switching transistors of a switched-mode converter according to a sequence of the type described in relation with FIGS. 3A and 3B.

Specific embodiments of the present invention have been described. Various alterations, modifications and improvements will readily occur to those skilled in the art.

In particular, the present invention has been described, as an example, in relation with a buck converter. It is however not limited to this specific case. It will be within the abilities of those skilled in the art to adapt the provided operation to any switched-mode converter in which the regulation of an output signal is ensured by switching a node of an electric circuit between first and second states. As an example, it will be within the abilities of those skilled in the art to adapt the provided solution to a boost converter or to a class-D amplifier.

Further, the present invention is not limited to the above-described examples in which the switching transistors are a P-channel MOS transistor in series with an N-channel MOS transistor between high and low terminals of the converter. It will be within the abilities of those skilled in the art to adapt the provided solution to other configurations. The high, low, and intermediary levels of control signals VG1 and VG2 of the switching transistors will then be adapted accordingly.

Further, the present invention is not limited to the numerical examples mentioned as an example hereabove. In particular, it will be within the abilities of those skilled in the art to implement the desired operation whatever the converter chopping frequency and whatever the threshold voltages of switching transistors 1 and 2.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A switched-mode converter comprising:
a first chopper transistor;
a second chopper transistor; and
control means for:
maintaining the first and second chopper transistors respectively on and off during first operating phases;
maintaining the first and second transistors respectively off and on during second operating phases; and
applying an intermediary voltage to a gate of the second transistor during intermediary phases taking place between the first and second operating phases, the intermediary voltage being close to a threshold voltage of the second chopper transistor.

2. The converter of claim 1, wherein the first chopper transistor is a P-channel MOS transistor and the second chopper transistor is an N-channel MOS transistor, the first and second chopper transistors coupled in series between a high terminal and a low terminal of the converter.

3. The converter of claim 2, wherein the intermediary voltage is smaller than the threshold voltage of the second transistor by 50 mV to 150 mV.

4. The converter of claim 1, wherein the intermediary phases have a duration ranging between 1% and 10% of a full switching cycle period of the converter.

5. The converter of claim 1, wherein the control means comprises:
a first switch for connecting a gate of the first transistor to a terminal at a first voltage during the first operating phases, and to a terminal at a second voltage during the second operating phases and the intermediary phases;
a second switch for connecting the gate of the second transistor to a terminal at a third voltage during the first operating phases, to a terminal at a fourth voltage during the second operating phases, and to an intermediary node during the intermediary phases; and
means for applying the intermediary voltage to the intermediary node during the intermediary phases.

6. The converter of claim 5, wherein the means for applying the intermediary voltage comprise a diode-assembled transistor, biased by a current source.

7. The converter of claim 1, wherein the converter is connected as a voltage step-down transformer.

8. The converter of claim 1, wherein the converter is connected as a voltage step-up transformer.

9. The converter of claim 1, wherein the converter is connected as a class-D amplifier.

10. A switched-mode converter comprising:
a first chopper transistor;
a second chopper transistor; and
control circuitry configured to maintain the first chopper transistor on and the second chopper transistor off during first operating phases, to maintain the first chopper transistor off and the second chopper transistor on during second operating phases, and to apply an intermediary voltage to a control terminal of the second chopper transistor during intermediary phases that take place between the first and second operating phases, the intermediary voltage being close to a threshold voltage of the second chopper transistor.

11. The converter of claim 10, wherein the first chopper transistor is a P-channel MOS transistor and the second chopper transistor is an N-channel MOS transistor, the first and second chopper transistors coupled in series between a high terminal and a low terminal of the converter.

12. The converter of claim 11, wherein the intermediary voltage is smaller than the threshold voltage of the second chopper transistor by 50 mV to 150 mV.

13. The converter of claim 10, wherein the intermediary phases have a duration ranging between 1% and 10% of a full switching cycle period of the converter.

14. The converter of claim 10, wherein the control circuitry comprises:
a first switch for connecting a control terminal of the first chopper transistor to a terminal at a first voltage during the first operating phases, and to a terminal at a second voltage during the second operating phases and the intermediary phases; and
a second switch for connecting the control terminal of the second chopper transistor to a terminal at a third voltage during the first phases, to a terminal at a fourth voltage during the second operating phases, and to an intermediary node during the intermediary phases.

15. The converter of claim 14, wherein the control circuitry further comprises a circuit configured to apply the intermediary voltage to the intermediary node during the intermediary phases.

16. The converter of claim 14, wherein the control circuitry further comprises means for applying the intermediary voltage to the intermediary node during the intermediary phases.

17. The converter of claim 14, wherein the control circuitry further comprises a diode-connected transistor coupled to a control terminal of the second switch.

18. The converter of claim 17, wherein the diode-connected transistor is biased by a current source.

19. The converter of claim 10, wherein the converter is connected as a voltage step-down transformer.

20. The converter of claim 10, wherein the converter is connected as a voltage step-up transformer.

21. The converter of claim 10, wherein the converter is connected as a class-D amplifier.

22. A circuit comprising:
a first transistor having a current path between a first source/drain region and a second source/drain region and a gate, the first source/drain region coupled to a first input terminal;
a second transistor having a current path between a first source/drain region and a second source/drain region and a gate, the first source/drain region coupled to a second input terminal and the current path of the second transistor coupled in series with the current path of the first transistor;
a diode-connected transistor having a current path between a first source/drain region and a second source/drain region and a gate, the second source/drain region of the diode-connected transistor being coupled to the gate of the diode-connected transistor;
a current source coupled in series with the current path of the diode-connected transistor between the first input terminal and the second input terminal;
a first switch coupled to the gate of the first transistor so as to connect the gate to either a gate high voltage terminal or to a gate low voltage terminal; and
a second switch coupled to the gate of the second transistor so as to connect the gate to either the gate high voltage terminal or to a gate low voltage terminal or the gate of the diode-connected transistor.

23. The circuit of claim 22, further comprising:
an inductor with a first terminal coupled to the second source/drain region of the first and second transistors; and
a capacitor with a first terminal coupled to a second terminal of the inductor.

24. The circuit of claim 23, wherein the capacitor further includes a second terminal coupled to the second input terminal, the second input terminal comprising a ground terminal.

25. The circuit of claim 24, wherein the gate low voltage terminal also comprises a ground terminal and wherein the gate high voltage terminal is connected to the first input terminal.

26. The circuit of claim 22, further comprising a third switch coupled with a current path coupled in series with the current source and the diode-connected transistor.

27. The circuit of claim 22, wherein the first transistor is a P-channel MOS transistor and the second transistor is an N-channel MOS transistor.

28. A circuit comprising:
a first transistor having a current path between a first source/drain region and a second source/drain region and a gate, the first source/drain region coupled to a first input terminal;
a second transistor having a current path between a first source/drain region and a second source/drain region and a gate, the first source/drain region coupled to a second input terminal and the current path of the second transistor coupled in series with the current path of the first transistor;
a third transistor having a current path between a first source/drain region and a second source/drain region and a gate, the second source/drain region of the third transistor being coupled to the gate of the third transistor;
a first switch coupled to the gate of the first transistor so as to connect the gate to either a gate high voltage terminal or to a gate low voltage terminal;
a second switch coupled to the gate of the second transistor so as to connect the gate to either the gate high voltage terminal or to the gate low voltage terminal or the gate of the third transistor;
a fourth transistor having a current path between a first source/drain region and a second source/drain region and a gate, the current path of the fourth transistor coupled in series with the current path of the third transistor;
a third switch with a current path coupled in series with the current path of the third transistor and the current path of the fourth transistor;
a fifth transistor having a current path between a first source/drain region and a second source/drain region and a gate, the second source/drain region of the fifth transistor being coupled to the gate of the fifth transistor and the gate of the fifth transistor being coupled to the gate of the fourth transistor;
a sixth transistor having a current path between a first source/drain region and a second source/drain region and a gate, the second source/drain region of the sixth transistor being coupled to the gate of the sixth transistor; and
a current source coupled in series with the current paths of the fifth transistor and the sixth transistor.

29. The circuit of claim 28, further comprising:
an inductor with a first terminal coupled to the second source/drain region of the first and second transistors; and
a capacitor with a first terminal coupled to a second terminal of the inductor.

30. The circuit of claim 29, wherein the capacitor further includes a second terminal coupled to the second input terminal, the second input terminal comprising a ground terminal.

31. The circuit of claim 30, wherein the gate low voltage terminal also comprises a ground terminal and wherein the gate high voltage terminal is connected to the first input terminal.

32. The circuit of claim 28, wherein the first transistor is a P-channel MOS transistor and the second transistor is an N-channel MOS transistor.

33. The circuit of claim 28, further comprising:
a fourth switch coupled between the second source/drain region of the third transistor and the gate of the third transistor; and
a fifth switch coupled between the gate of the third transistor and the gate high voltage terminal.

34. The circuit of claim 33, further comprising:
an inductor with a first terminal coupled to the second source/drain region of the first and second transistors; and
a capacitor with a first terminal coupled to a second terminal of the inductor and a second terminal coupled to the second input terminal;
wherein the second input terminal comprises a ground terminal;
wherein the gate low voltage terminal also comprises a ground terminal; and
wherein the gate high voltage terminal is connected to the first input terminal.

35. A method of operating a converter that comprises a first chopper transistor coupled in series with a second chopper transistor between input terminals, the method comprising:
maintaining the first chopper transistor on and the second chopper transistor off during first operating phases;
maintaining the first chopper transistor off and the second chopper transistor on during second operating phases; and
applying an intermediary voltage to a gate of the second chopper transistor during intermediary phases that take place between the first and second operating phases, the intermediary voltage being close to a threshold voltage of the second chopper transistor.

36. The method of claim 35, wherein the first chopper transistor is a P-channel MOS transistor and the second chopper transistor is an N-channel MOS transistor.

37. The method of claim 36, wherein the intermediary voltage is smaller than the threshold voltage of the second transistor by 50 mV to 150 mV.

38. The method of claim 35, wherein the intermediary phases have a duration ranging between 1% and 10% of a full switching cycle period of the converter.

39. The method of claim 35, wherein the intermediary phases have a duration ranging between 1 ns and 5 ns.

40. The method of claim 39, wherein the intermediary phases have a duration ranging between 1% and 10% of a full switching cycle period of the converter.
